(19) United States
(12) Patent Application Publication
(10) Pub. No.: US 2013/0091676 A1
(43) Pub. Date: Apr. 18, 2013

(54) LAWN MOWER BLADE SHARPENER AND METHOD OF USING SAME

(71) Applicant: Robert W. Schuetz, Beckley, WV (US)

(72) Inventor: Robert W. Schuetz, Beckley, WV (US)

(21) Appl. No.: 13/646,894

(22) Filed: Oct. 8, 2012

Related U.S. Application Data
(60) Provisional application No. 61/547,126, filed on Oct. 14, 2011.

(51) Int. Cl. B23D 71/08; B23D 67/12

(52) U.S. Cl. 29/76.4; 29/76.1

(57) ABSTRACT

A lawn mower blade sharpener and a method of sharpening a lawn mower blade attached to a lawn mower. The lawn mower blade sharpener includes a body having an opening that is disposed within the body along the length of the body, and a file within the opening, wherein the file includes a first file having an arcuate surface and a second file having a flat surface.

### CROSS-REFERENCES TO RELATED APPLICATIONS

This application claims the benefit of U.S. Provisional Application Ser. No. 61/547,126, filed Oct. 14, 2011. The entire contents of that application are incorporated by reference herein.

### TECHNICAL FIELD

The disclosed embodiments relate generally to a manual hand-held lawn mower blade sharpener and a method of using a manual hand-held lawn mower blade sharpener, and more particularly, to save time and money as well as improve safety for the user by sharpening lawn mower blades using the manual hand-held lawn mower blade sharpener without removing the lawn mower blades from the lawn mower.

### BACKGROUND

While there are several prior art devices and methods for sharpening a lawn mower blade, there remains a need in the art for an improved manual hand-held lawn mower sharpener for sharpening a lawn mower blade without removing the lawn mower blade from the lawn mower.

### SUMMARY

Against the above background, the present invention is directed to a manual hand-held lawn mower blade sharpener and a method of sharpening a least one lawn mower blade without removing the lawn mower blade from a lawn mower in order to save time and money as well as improve safety for the user while exercising the method of sharpening the lawn mower blade described herein.

In one embodiment, a lawn mower blade sharpener may comprise a body having an opening that is disposed within the body along the length of the body, and a file within the opening, wherein the file comprises a first file having an arcuate surface and a second file having a flat surface.

In another embodiment, a lawn mower blade sharpener for sharpening a lawn mower blade may comprise a body having an opening that is disposed within the body along the length of the body, at least one grip disposed on the body for holding the sharpener, and a two part file within the opening, wherein the two part file comprises a first file having an arcuate surface and a second file having a flat surface.

In yet a further embodiment, a method of sharpening a lawn mower blade attached to a lawn mower may comprise the use of a lawn mower blade sharpener. The sharpener may comprise a body having an opening that is disposed within the body along the length of the body, and a file within the opening, wherein the file may comprise a first file having an arcuate surface and a second file having a flat surface. The method includes inserting the lawn mower blade within the opening of the body of the sharpener such that the first file is adjacent a top surface of the lawn mower blade and the second file is adjacent a bottom surface of the lawn mower blade, and moving the sharpener manually with one hand in a back and forth motion over the top surface and bottom surface of the lawn mower blade, thereby sharpening the top surface and bottom surface of the lawn mower blade simultaneously by direct contact with the first file and the second file without removing the lawn mower blade from the lawn mower.

These and other features, aspects, and advantages of the present invention will become better understood with reference to the following description and the appended claims.

### BRIEF DESCRIPTION OF THE DRAWINGS

Though the specification concludes with claims particularly pointing out and distinctly claiming the invention, it is believed that the present invention will be better understood from the following description taken in conjunction with the accompanying drawings, in which:

FIG. 1 is a perspective view of a lawn mower blade sharpener according to one or more embodiments shown and described herein;

FIG. 2 is a left elevational view of the lawn mower blade sharpener of FIG. 1 according to one or more embodiments shown and described herein;

FIG. 3 is a perspective view of a lawn mower blade sharpener for sharpening a lawn mower blade, wherein a lawn mower blade is inserted within the lawn mower blade sharpener according to one or more embodiments shown and described herein; and

FIG. 4 is cross sectional view of the lawn mower blade sharpener taken along 4-4 of FIG. 3 according to one or more embodiments shown and described herein.

### DETAILED DESCRIPTION

Features and advantages of the invention will now be described with occasional reference to specific embodiments. However, the invention may be embodied in different forms and should not be construed as limited to the embodiments set forth herein. Rather, these embodiments are provided so that this disclosure will be thorough and complete and will fully convey the scope of the invention to those skilled in the art.

Unless otherwise defined, all technical terminology used herein have the same meaning as commonly understood by one of ordinary skill in the art to which the invention belongs. The terminology used in the description herein is for describing particular embodiments only and is not intended to be limiting. As used in the specification and appended claims, the singular forms “a,” “an,” and “the” are intended to include the plural forms as well, unless the context clearly indicates otherwise.

An apparatus and method of sharpening a lawn mower blade by sharpening lawn mower blades without removing the lawn mower blades from the lawn mower is disclosed herein. The apparatus is a manual lawn mower blade sharpener capable of being held in one hand. The method of sharpening a lawn mower blade includes using the disclosed apparatus to sharpen both sides, top and bottom, of a lawn mower blade simultaneously, with a simple back and forth motion without taking the lawn mower blade off of the lawn mower.

The lawn mower blade sharpener comprises a body having an opening that is disposed within the body along the length of the body and a file within the opening, wherein the file comprises a first, top, file and a second, bottom, file. The body of the sharpener may be made of a rubber material. The lawn mower blade sharpener may further comprise at least one grip disposed on the body for holding the sharpener in one hand and designed as a non slip feature. The grip may be raised grooves to provide the user with easy handling and safety feature so that the sharpener does not slip from the users hand while in use. The grip may be made of a rubber material. The file within the opening comprises a first, top, file having a buldged or arcuate surface which corresponds to the top beveled surface of a lawn mower blade, and a second, bottom, file having a straight or flat surface which corresponds to the bottom straight or smooth surface of a lawn mower blade. The first file and second file consists of a hardened carbon steel or tungsten carbide material, may be a length of at least between about 2 inches to 3 inches, a width of at least between about 1 inch to 2 inches and having an angle of at least between about 5° to 30° between the first file and the second file. The body of the sharpener is manufactured with indentations at the opening to receive the first file and second file, wherein the first file and second file are welded within the indentations at the opening of the body. Thus, the angle between the first file and the second file corresponds with the angle on the cutting edge of the top surface of a lawn mower blade. As one skilled in the art would recognize the cutting edge of a lawn mower blade is about 3 inches in length, therefore allowing the user to move the lawn mower blade sharpener having a length of at least about 2 inches to 3 inches, in a back and forth motion, or in a motion from right to left or left to right, without removing the lawn mower blade from the lawn mower.

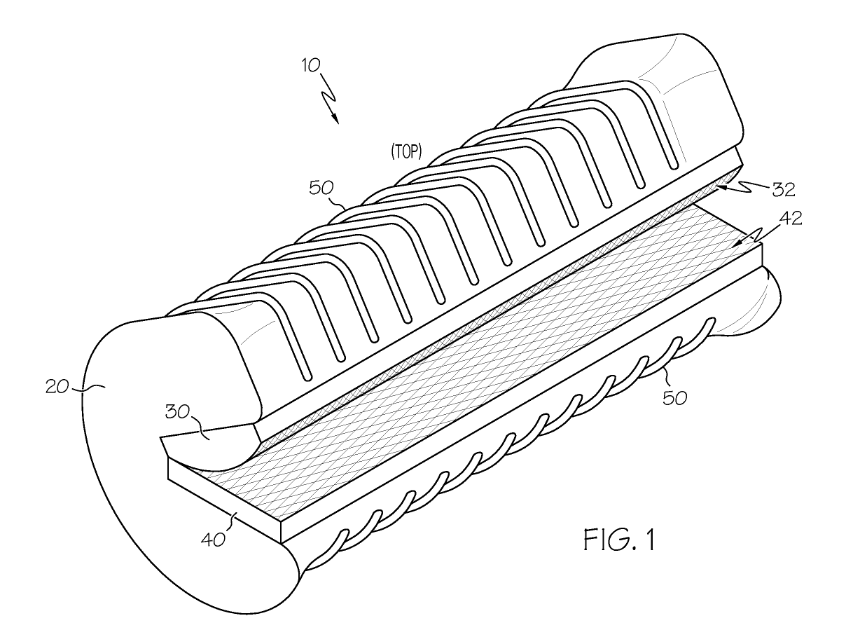

For illustration purposes, and not limitation, the following embodiments of the apparatus 10 will be described with reference to a lawn mower blade sharpener. Referring to FIG. 1, the lawn mower blade sharpener is shown as a perspective view thereof. In general, the apparatus 10 includes a body 20 having an opening that is disposed within the body 20 along the length of the body 20, a file within the opening, wherein the file comprises a first file 30 having an arcuate or buldged surface 32 and a second file 40 having a flat or straight surface 42, and at least one grip 50 disposed on the body 20 for holding the lawn mower blade sharpener 10 in one hand.

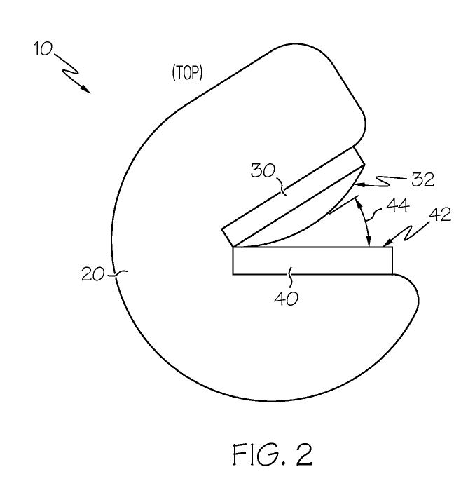

FIG. 2 is a left elevational view of the lawn mower blade sharpener 10 of FIG. 1, including a body 20 having an opening that is disposed within the body 20 along the length of the body 20, a file within the opening, wherein the file comprises a first file 30 having an arcuate or buldged surface 32 and a second file 40 having a flat or straight surface 42, wherein an angle 44 between the first file 30 and the second file 40 is at least between about 5° to 30°.

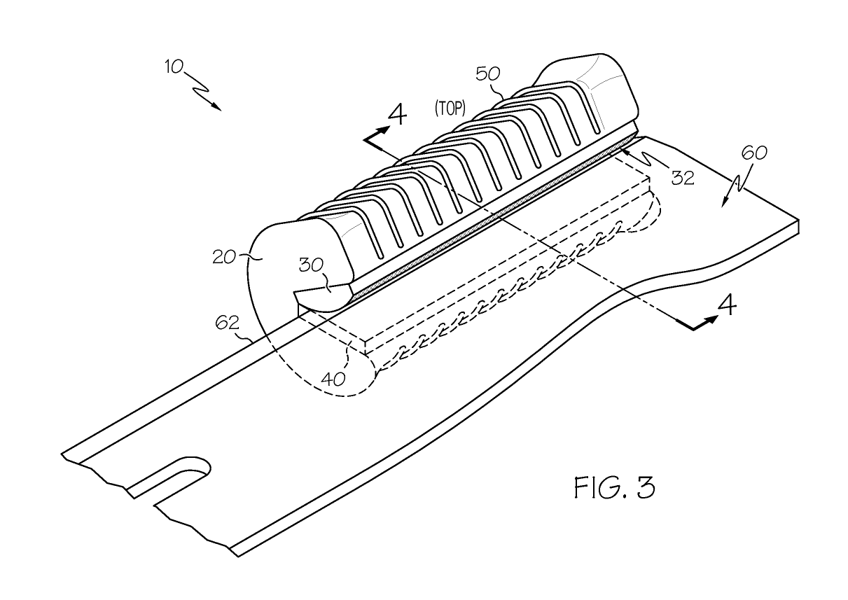

FIG. 3 is a perspective view of a lawn mower blade sharpener 10 for sharpening a lawn mower blade, wherein a lawn mower blade is inserted within the opening of the body of the lawn mower blade sharpener 10. The lawn mower blade sharpener provides a user with a method for sharpening a top surface and a bottom surface of a lawn mower blade without removing the lawn mower blade from the lawn mower. As shown in FIG. 3, the apparatus useful in this method includes a body 20 having an opening that is disposed within the body 20 along the length of the body 20, a file within the opening, wherein the file includes a first file 30 having an arcuate or buldged surface 32 and a second file 40 (not shown) having a flat or straight surface 42. In some embodiments, the first file 30 and second file 40 are at an angle 44 between the first file 30 and the second file 40 of at least between about 5° to 30°. At least one grip is 50 disposed on the body 20. As such, a user may insert the lawn mower blade within the opening of the body 20 of the sharpener 10 such that the first file 30 is adjacent a top surface 60 of a lawn mower blade and the second file 40 is adjacent a bottom surface 70 of a lawn mower blade. The angle 44 between the first file 30 and the second file 40 corresponds with the angle on the cutting edge 62 of the top surface 60 of the lawn mower blade. The user may then move the sharpener 10 manually with one hand in a manual, back and forth motion over the top surface 60 and bottom surface 70 of the lawn mower blade, resulting in the top surface 60 and bottom surface 70 of the lawn mower blade to be sharpened simultaneously by direct contact with the first file 30 and the second file 40 without removing the lawn mower blade from the lawn mower.

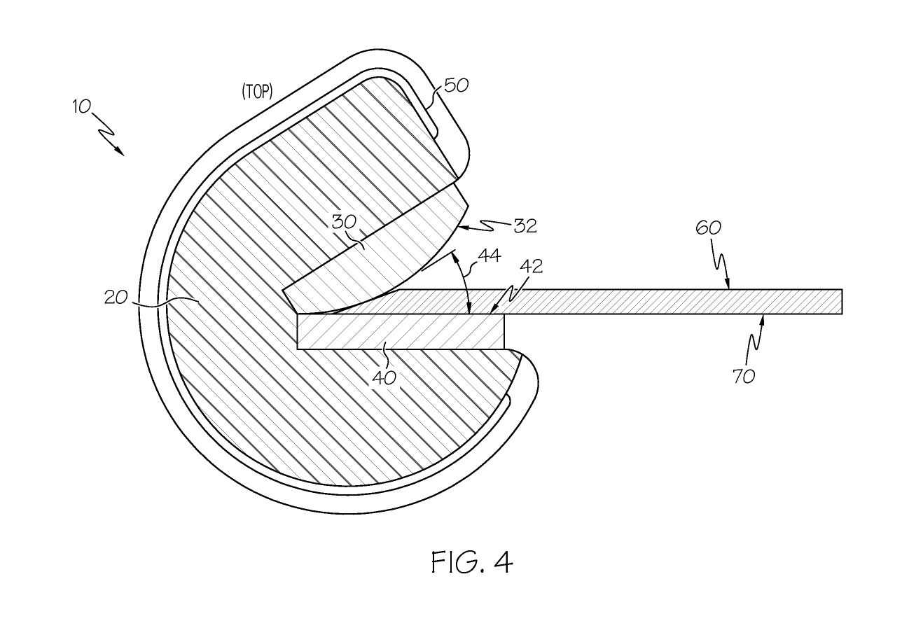

FIG. 4 is cross sectional view of the lawn mower blade sharpener 10 taken along 4-4 of FIG. 3. As shown in this Figure, the apparatus has a body 20 with an opening that is disposed within the body 20 along the length of the body 20, and a file within the opening, wherein the file comprises a first file 30 having an arcuate or buldged surface 32 and a second file 40 having a flat or straight surface 42. The angle 44 between the first file 30 and the second file 40 consists of at least between about 5° to 30°. The figure further depicts a lawn mower blade consisting of a top surface 60 and bottom surface 70. As one skilled in the art would recognize, the top surface 60 of the lawn mower blade consists of a beveled surface and the bottom surface 70 of the lawn mower blade consists of a straight or smooth surface. Therefore, the angle 44 between the first file 30 and the second file 40 allows for the top surface 60 and bottom surface 70 of the lawn mower blade to be inserted into the opening of the body 20 of the lawn mower blade sharpener 10 in order to manually sharpen simultaneously both surfaces, top surface 60 and bottom surface 70, of the lawn mower blade by direct contact with the first file 30 and the second file 40 without removing the lawn mower blade from the lawn mower.

Though the invention has been described in detail and by reference to specific embodiments of the invention, it will be apparent that modifications and variations are possible without departing from the scope of the invention defined in the appended claims. More specifically, although some aspects of the present invention are identified herein as preferred or particularly advantageous, it is contemplated that the present invention is not necessarily limited to these preferred aspects of the invention.

What is claimed is:

1. A lawn mower blade sharpener, the sharpener comprising:
a body having an opening that is disposed within the body along the length of the body; and
a file within the opening, wherein the file comprises a first file having an arcuate surface and a second file having a flat surface.

2. The sharpener of claim 1, further comprising at least one grip disposed on the body for holding the sharpener.

3. The sharpener of claim 1, wherein the file is a steel file.

4. The sharpener of claim 1, wherein the file comprises a length of at least about 2.5 inches, a width of at least about 1.5 inches and having an angle of at least about 20° between the first file and the second file.

5. The sharpener of claim 1, wherein the body comprises a plastic or rubber material.

6. The sharpener of claim 1, wherein the sharpener is a manual sharpener capable of being held in one hand and moved in a back and forth motion over at least one lawn mower blade, the at least one lawn mower blade comprising a top surface and a bottom surface without removing the at least one lawn mower blade from a lawn mower.

7. The sharpener of claim 6, wherein the top surface of the at least one lawn mower blade is a beveled surface and the bottom surface of the at least one lawn mower blade is a smooth surface.

8. A lawn mower blade sharpener for sharpening a lawn mower blade, the sharpener comprising:
a body having an opening that is disposed within the body along the length of the body;
at least one grip disposed on the body for holding the sharpener; and
a two part file within the opening, wherein the two part file comprises a first file having an arcuate surface and a second file having a flat surface.

9. The sharpener of claim 8, wherein the two part file is a steel file.

10. The sharpener of claim 8, wherein the two part file comprises a length of at least about 2.5 inches, a width of at least about 1.5 inches and having an angle of at least about 20° between the first file and the second file.

11. The sharpener of claim 8, wherein the body and the at least one grip comprises a plastic or rubber material.

12. The sharpener of claim 8, wherein the sharpener is a manual sharpener capable of being held in one hand and moved in a back and forth motion over at least one lawn mower blade, the at least one lawn mower blade comprising a top surface and a bottom surface without removing the at least one lawn mower blade from a lawn mower.

13. The sharpener of claim 12, wherein the top surface of the at least one lawn mower blade is a beveled surface and the bottom surface of the at least one lawn mower blade is a smooth surface.

14. A method of sharpening a lawn mower blade attached to a lawn mower, said method comprising:
a lawn mower blade sharpener, the sharpener comprising a body having an opening that is disposed within the body along the length of the body, and a file within the opening, wherein the file comprises a first file having an arcuate surface and a second file having a flat surface;
inserting the lawn mower blade within the opening of the body of the sharpener such that the first file is adjacent a top surface of the lawn mower blade and the second file is adjacent a bottom surface of the lawn mower blade;
moving the sharpener manually with one hand in a back and forth motion over the top surface and the bottom surface of the lawn mower blade; and
sharpening the top surface and the bottom surface of the lawn mower blade simultaneously by direct contact with the first file and the second file without removing the lawn mower blade from the lawn mower.

15. The method of claim 14, wherein the top surface of the lawn mower blade is a beveled surface and the bottom surface of the lawn mower blade is a smooth surface.

16. The method of claim 14, wherein the file is a steel file.

17. The method of claim 14, wherein the file comprises a length of at least about 2.5 inches, a width of at least about 1.5 inches and having an angle at least about 20° between the first file and the second file.

18. The method of claim 14, wherein the sharpener further comprises at least one grip disposed on the body for holding the sharpener.

19. The method of claim 14, wherein the body comprises a plastic or rubber material.
